(19) United States
(12) Patent Application Publication
(10) Pub. No.: US 2002/0189566 A1
(43) Pub. Date: Dec. 19, 2002

(54) Miniature engine starter

(76) Inventor: James E. Smalley JR., Orlando, FL (US)

Correspondence Address: Edward M. Livingston, Esq., 628 Ellen Dr., P.O. Box 1599, Winter Park, FL, 32790, US

(21) Appl. No.: 09/873,890

(22) Filed: Jun. 4, 2001

(51) Int. Cl. F02N 11/00

(52) U.S. Cl. 123/179.26; 74/6

(57) ABSTRACT

A miniature-engine starter has a starter wheel (1) with a starter rim (2) that engages tangentially a flywheel rim (3) of a flywheel (4) of a miniature engine (5). The starter wheel is rotatable on a starter axle (9) that can be situated parallel to an axis of the flywheel and thereby starter-actuate the miniature engine. The starter axle is on a starter bracket (17) which can be hand-held or fastener-attached to an engine platform (6) to which the miniature engine is attached. The starter wheel has a transmission (7, 8, 13) to which a motorized rotator (22) is engaged for rotation while the starter rim is held firmly but removably against the flywheel for rotation to start the miniature engine. The starter rim can be rubberlike to engage grip indentations (19) or can have starter gear teeth (21) to mate with flywheel gear teeth (20).

### BACKGROUND OF THE INVENTION

This invention relates to starting a miniature engine on a remote-control model vehicle that can be hand held. In particular, it relates to starting the miniature engine with a rubber wheel that is pressed against a serrated rim of the engine's flywheel and rotated with an electrically rotated tool.

Operating and racing small model vehicles that resemble giant-tire off-road vehicles has become a popular pastime. Usually these model vehicles are slightly over a foot square, eight inches high and have wide tires with diameters over five inches. They are powered by miniature engines similar to model-airplane engines but usually a bit heavier. The model-vehicle engines generally have one cylinder that turns a crankshaft and has a flywheel on an end opposite a power takeoff. The flywheel is generally serrated for being finger-turned when not surrounded by use-related components.

For being started, the model vehicles as sold most generally have miniature electric starters with a battery. Alternatively for being started, some of the model vehicles have pull ropes like some lawnmower and power saw engines.

For a popular use of the model vehicles for racing, there is a problem of too much weight of the electrical starter with its battery capacity. For the pull rope, there is a problem of inconvenience and frequent breakage of the pull rope and damage to the model vehicle from attempting to hold it down while being pull-rope started.

A further problem occurs from putting slightly more powerful “large-bore” miniature engines on the model vehicles. The more powerful miniature engines require pull-rope starting which is difficult and often results in injury to the user and breakage of the pull rope, which is expensive to replace.

Typical of miniature motors generally, however, most have flywheels that are serrated for finger turning when being manufactured and tested.

There is no known convenient, light-weight and damage-preventive system for starting miniature engines on model vehicles in a manner taught by this invention.

Examples of most-closely related known but different devices are described in the following patent documents:

| U.S. Pat. No. | Inventor | Issue Date |
|---|---|---|
| 4,615,311 | Scheckel | Oct. 7, 1986 |
| 4,157,083 | Smith, et al. | June 5, 1979 |
| 4,531,482 | Scheckel | July 30, 1985 |
| 5,345,900 | Wisegerber | Sept. 13, 1994 |
| 4,365,596 | Bennett, Sr. | Dec. 28, 1982 |
| 3,885,544 | Pfeiffer | May 27, 1975 |
| 3,596,647 | Heisler | Aug. 3, 1971 |
| 3,394,598 | Hoch | July 30, 1968 |
| 4,569,315 | Bodnar | Feb. 11, 1986 |

### SUMMARY OF THE INVENTION

Objects of patentable novelty and utility taught by this invention are to provide a miniature-engine starter which:

utilizes an electric-motor tool or other motorized rotator for starting the engine;

is small to avoid physical interference and objectionable appearance;

is light to minimize racing weight;

can be made to be attached and removed conveniently;

can be made for use without physical attachment;

does not require alteration of the engine; and

requires only minimal hole boring for attachment for an attachable embodiment.

This invention accomplishes these and other objectives with a miniature-engine starter having a starter wheel with a starter rim that engages tangentially a flywheel rim of a flywheel of a miniature engine. The starter wheel is rotatable on a starter axle that can be situated parallel to an axis of the flywheel for rotating a crankshaft and thereby starter-actuating the miniature engine. The starter axle is on a starter bracket which can be hand-held or fastener-attached to an engine platform to which the miniature engine is attached. The starter wheel has a shaft coupling to which a shaft of an electrically rotated device or tool is engaged for rotation while the starter rim is held firmly but removably against the flywheel for rotation to start the miniature engine. The starter rim can be rubberlike to engage a serrated or gear-toothed flywheel rim. Optionally, the starter rim can be gear-toothed to gear-mate with a gear-toothed flywheel.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF DRAWINGS

This invention is described by appended claims in relation to description of a preferred embodiment with reference to the following drawings which are explained briefly as follows:

FIG. 1 is a partially cutaway top view hand-held miniature-engine starter having a starter wheel engaged with a flywheel of a miniature engine on a model vehicle:

FIG. 2 is a partially cutaway section view from section line 1-1 of FIG. 1;

FIG. 3 is a fragmentary sectional view of the FIG. 2 illustration in which a starter wheel on a slide is removed from engagement with the flywheel of the miniature engine;

FIG. 4 is a fragmentary top view of the FIG. 1 miniature-engine starter having a universal joint on a starter-wheel axle for transmitting rotational power from an electrical rotator;

FIG. 5 is a partially cutaway sectional view from section line 1-1 of FIG. 1 modified to show a miniature-engine starter that is attached to the platform of a model vehicle and has a motorized rotator;

FIG. 6 is a fragmentary sectional view of the FIG. 5 illustration in which a starter wheel on a slide is removed from engagement with the flywheel of the miniature engine;

FIG. 7 is a fragmentary top view of the FIG. 5 miniature-engine starter having a starter transmission on a starter-wheel axle for transmitting rotational power from an electrical rotator;

FIG. 8 is a fragmentary sectional view of the FIG. 6 illustration in which the starter wheel on the slide is removed from engagement with the flywheel of the miniature engine and gear teeth instead of hand-grip serrations are employed on the flywheel rim and on the starter rim;

FIG. 9 is a fragmentary top view of the FIG. 7 miniature-engine starter having a rotator transmission on an axle of the motorized rotator for transmitting rotational power from the electrical rotator; and

FIG. 10 is an end view of the starter bracket on the slideway and showing in dashed lines the starter transmission and the rotator transmission.

### DESCRIPTION OF PREFERRED EMBODIMENT

Listed numerically below with reference to the drawings are terms used to describe features of this invention. These terms and numbers assigned to them designate the same features throughout this description.

| | | | |
|---|---|---|---|
| 1. | Starter wheel | 13. | Universal joint |
| 2. | Starter rim | 14. | Slide |
| 3. | Flywheel rim | 15. | Push handle |
| 4. | Flywheel | 16. | Bracket handle |
| 5. | Miniature engine | 17. | Starter bracket |
| 6. | Engine platform | 18. | Bracket extension |
| 7. | Starter transmission | 19. | Grip indentations |
| 8. | Rotator transmission | 20. | Flywheel gear teeth |
| 9. | Starter axle | 21. | Starter gear teeth |
| 10. | Starter bracket | 22. | Motorized rotator |
| 11. | Slideway | 23. | Releasable coupling |
| 12. | Model vehicle | | |

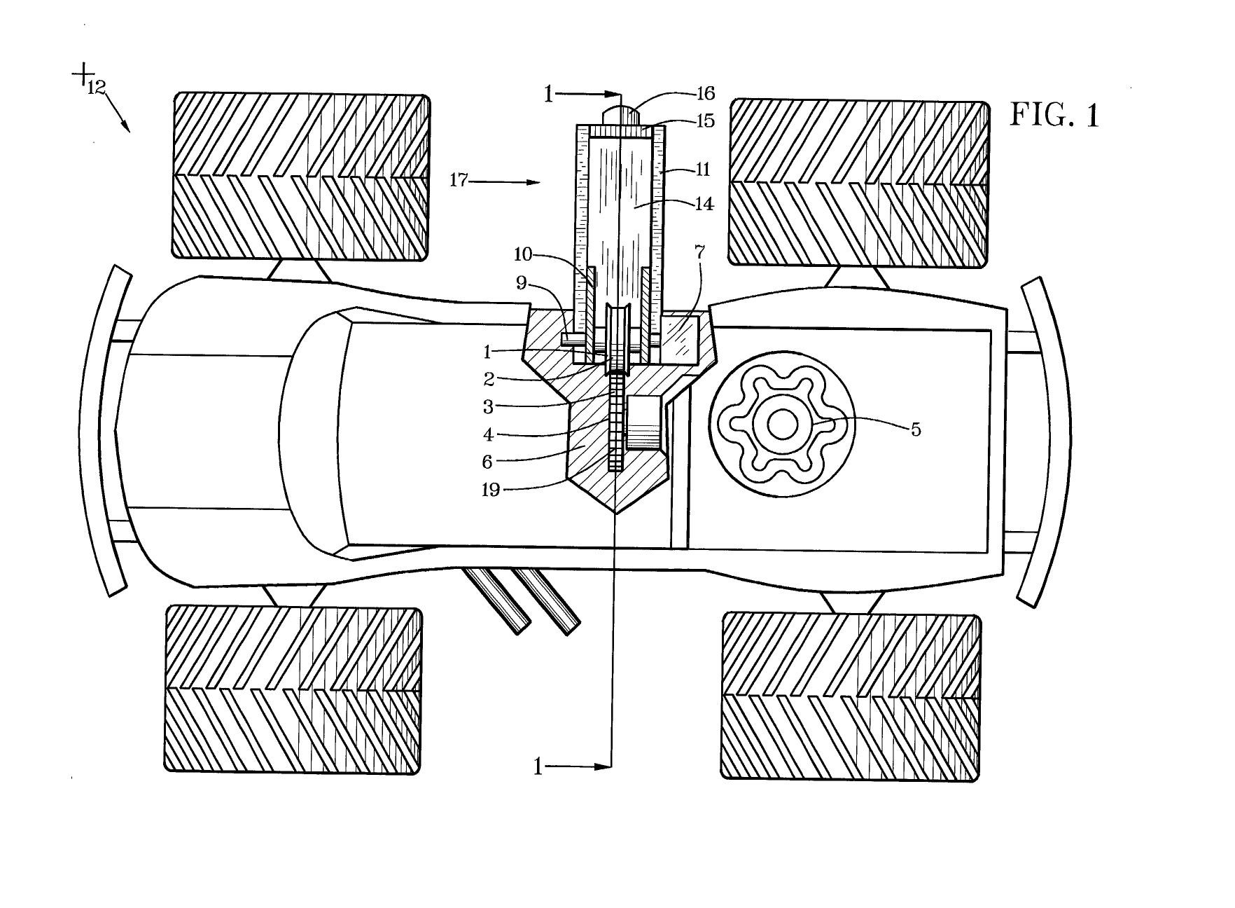

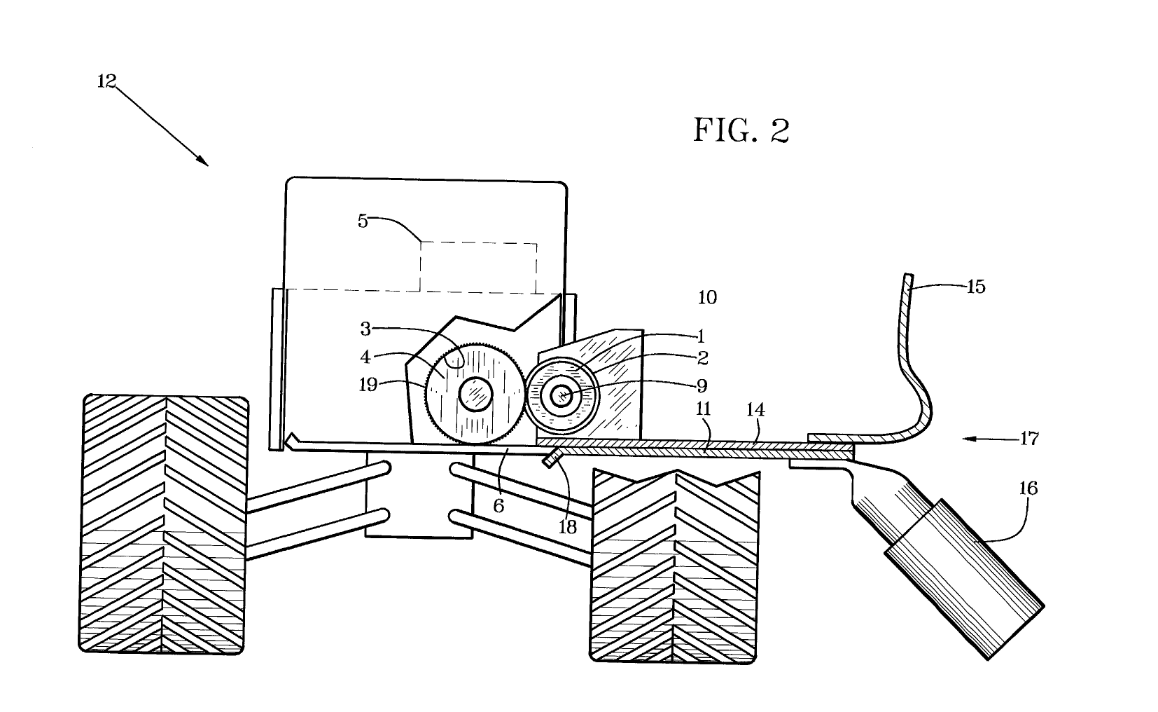

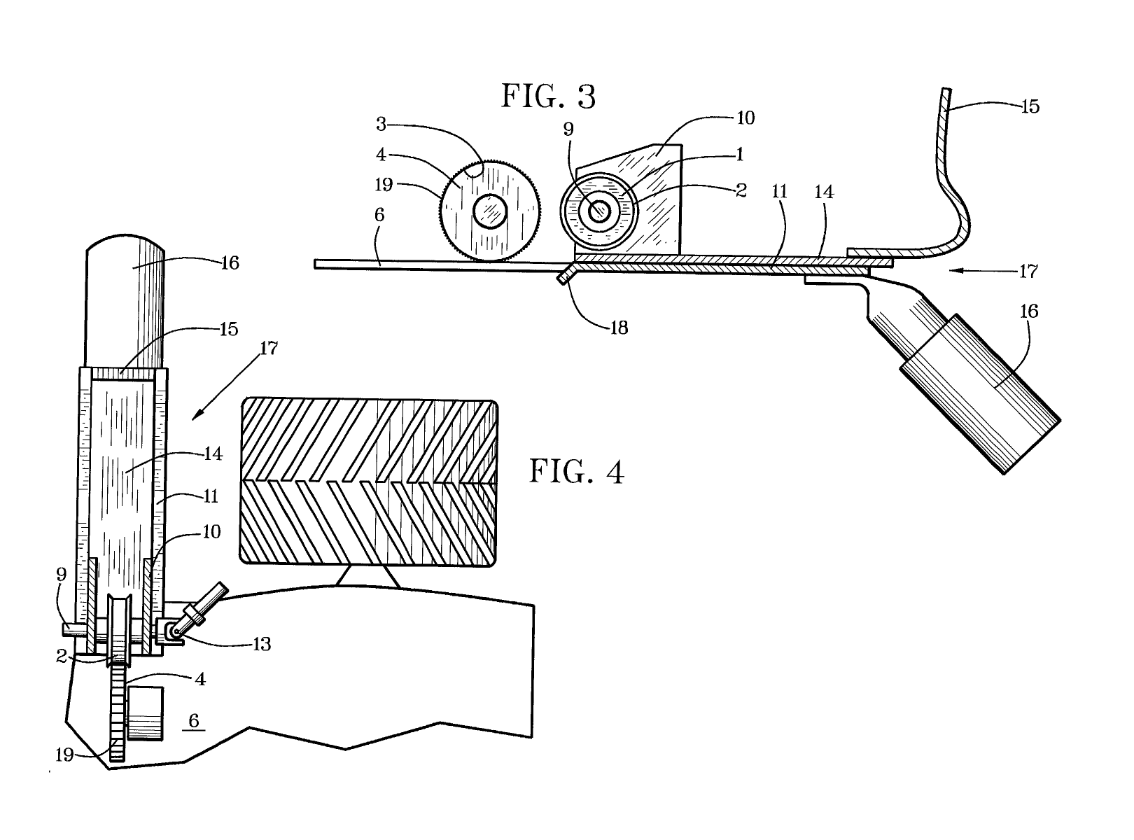

Referring to FIGS. 1-4, a starter wheel 1 has a starter rim 2 that is engaged tangentially with a flywheel rim 3 on a flywheel 4 of a miniature engine 5 on an engine platform 6 and rotated through a starter transmission 7 or optionally through a rotator transmission 8 shown in FIG. 9 for rotation to start the miniature engine 5.

The starter wheel 1 is rotatable on a starter axle 9 that is on a starter bracket 10 that is placed removably with the starter rim 2 and the flywheel rim 3 engaged tangentially in a starting mode. The starter bracket 10 includes a slideway 11 that optionally can be hand held or fastened to the engine platform 6 which is shown on a model vehicle 12. The starter wheel 1 has a power coupling which can include a universal joint 13, shown in FIG. 4, as a starter transmission 7 or optionally can include the rotator transmission 8 shown in FIG. 9.

The starter transmission 7 is an orthogonal-gearing component of the starter wheel 1 and the starter axle 9. The rotator transmission 8 is an orthogonal-gearing component of a rotator which can include an electrical tool or other rotationally motorized device. Either the starter transmission 7 or the rotator transmission 8 also can be speed-ratio geared as appropriate for engine starting.

The starter wheel 1 and the starter axle 9 are on a slide 14 that is slidable on the slideway 11 in a direction towards the flywheel 4 to engage the starter rim 2 and the flywheel rim 3 for the starting mode.

A push handle 15 on the slide 14 is used for hand-pushing the slide 14 to the starting mode. A bracket handle 16 on the starter bracket 17 is provided for hand-holding the starter bracket 17 while hand-pushing the slide 14 to the starting mode with the starter rim 2 and the flywheel rim 3 engaged.

The starter bracket 17 preferably includes a bracket extension 18 for engaging the engine platform 6 with the slide 14 in the starting mode and for removing the slide 14 from the engine platform 6 rapidly and conveniently after the miniature engine 5 is started.

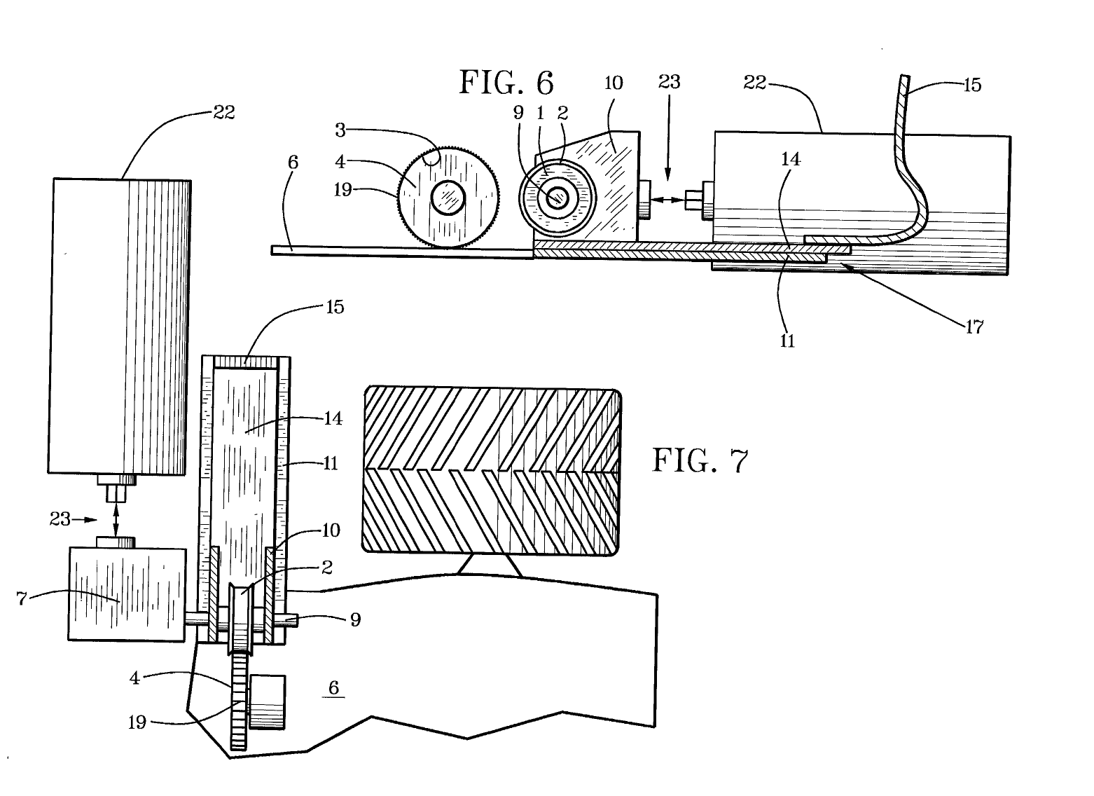

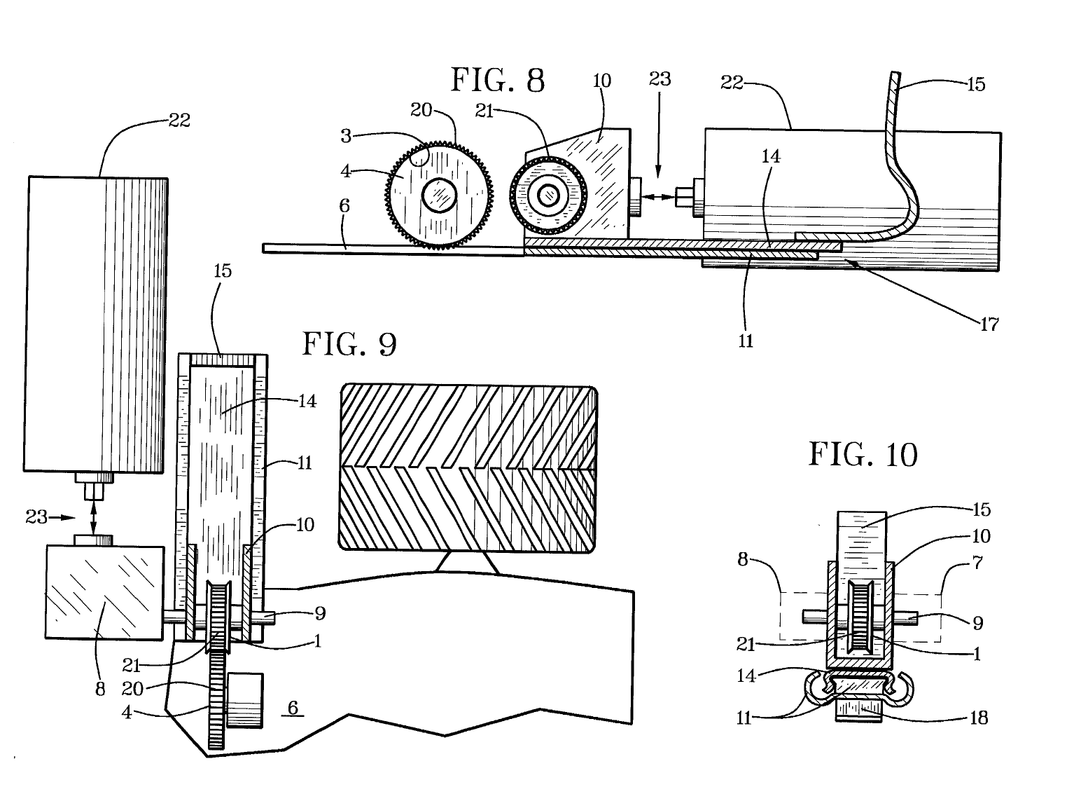

The flywheel rim 3 can include grip indentations 19 as depicted in FIGS. 1-7 or flywheel gear teeth 20 as depicted in FIGS. 8-9. For the grip indentations 19, the starter rim 2 is preferably a rubber like material as depicted in FIGS. 1-7. For the flywheel gear teeth 20, the starter rim 2 includes starter gear teeth 21 that are extended radially from the starter rim 2 to mate with the flywheel gear teeth 20 as depicted in FIGS. 8-10.

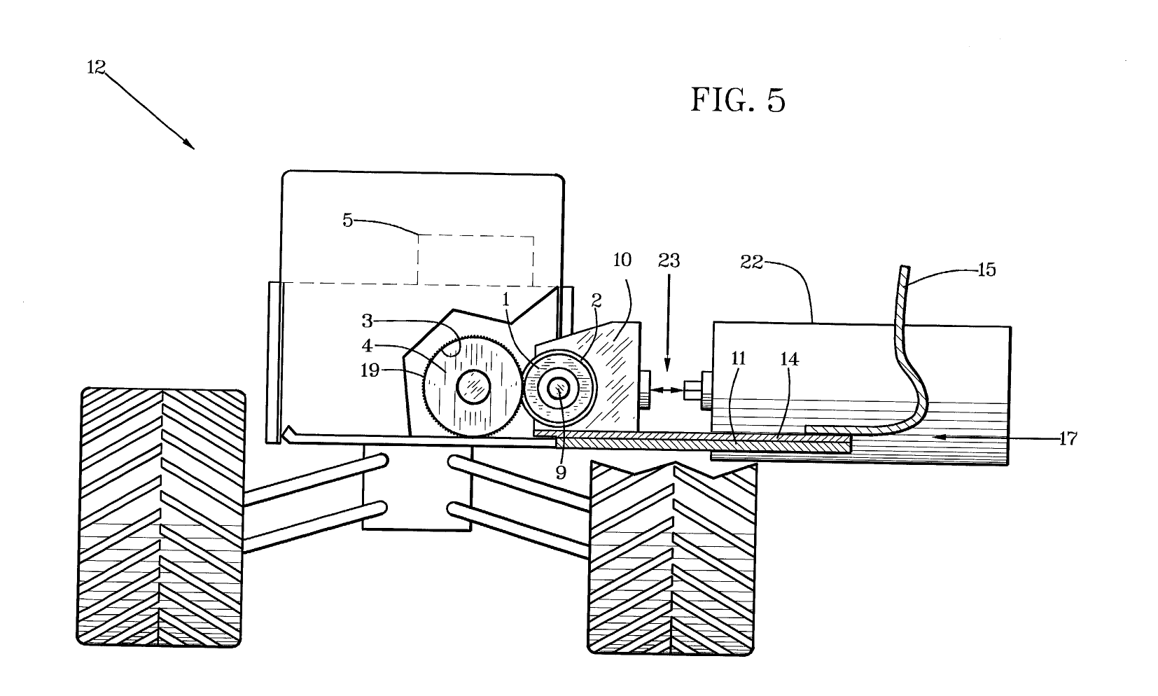

Referring to FIGS. 5-10, the starter bracket 17 can include a slideway 11 that is attachable to the engine platform 6 instead of being hand-held against it. This allows a starter transmission 7 shown in FIG. 7 or optionally a rotator transmission 8 shown in FIG. 9 to be situated removably on a front side of the flywheel 4 where there is sufficient room for a motorized rotator 22 in addition to either the starter transmission 7 or the rotator transmission 8. The motorized rotator 22 can have a releasable coupling 23 to engage the starter transmission 7 or the rotator transmission 8. The releasable coupling 23 can be a hexagon socket connection as depicted, a screwdriver connection or other rectangular or finned insertion coupling.

Pushing the releasable coupling 23 of the motorized rotator 22 into connection with the starter transmission 7 or the rotator transmission 8 can supplement or replace pushing the push handle 15 to achieve the starting mode with the starter rim 2 engaged with the flywheel rim 3.

The motorized rotator 22 can be powered electrically, with compressed air, with tensioned spring, with internal combustion, with steam or other source of motorized power. Electrical power is preferred for most but not all applications.

The motorized rotator 22 can be used in combination with either the attached embodiment described in relation to FIGS. 5-10 or the hand-held attachment described in relation to FIGS. 1-4.

A new and useful miniature-engine starter having been described, all such foreseeable modifications, adaptations, substitutions of equivalents, mathematical possibilities of combinations of parts, pluralities of parts, applications and forms thereof as described by the following claims and not precluded by prior art are included in this invention.

What is claimed is:

1. A miniature-engine starter for a miniature engine on an engine platform with a flywheel on the miniature engine having a flywheel rim, said starter comprising:
a starter wheel that is rotatable on a starter axle that is on a starter bracket;
the starter wheel having a starter rim that tangentially engages the flywheel rim in a starting mode;
the starter bracket being placed removably with the starter rim and the flywheel rim engaged in the starting mode; and
the starter wheel having a power coupling to which a predetermined motorized rotator is coupled predeterminedly.

2. The miniature-engine starter of claim 1 wherein:
the flywheel rim includes grip indentations; and
the starter rim includes a rubberlike circumferential outside periphery for resilience gripping of the flywheel rim.

3. The miniature-engine starter of claim 1 wherein:
the motorized rotator includes a rotator transmission having transmission of an axis of rotation from being collinear with an electrical-rotator axis to being predeterminedly collinear to a starter-wheel axis.

4. The miniature-engine starter of claim 1 wherein:
the starter wheel includes a starter transmission having transmission of an axis of rotation from being collinear with the starter-wheel axis to being predeterminedly collinear to the electrical-rotator axis.

5. The miniature-engine starter of claim 1 wherein:
the engine platform is on a model vehicle;
the starter bracket includes a slideway that is attached detachably to the engine platform;
the starter wheel and the starter axle are on a slide that is slidable on the slideway to the starting mode.

6. The miniature-engine starter of claim 1 wherein:
the flywheel rim includes flywheel gear teeth that are extended radially from the flywheel rim; and
the starter rim includes starter gear teeth that are extended radially from the starter rim to mate with the flywheel gear teeth.

7. A miniature-engine starter comprising:
a miniature engine on an engine platform of a model vehicle;
a flywheel on the miniature engine having a flywheel rim;
a starter wheel that is rotatable on a starter axle that is on a starter bracket;
the starter wheel having a starter rim that tangentially engages the flywheel rim in a starting mode;
the starter bracket being placed removably with the starter rim and the flywheel rim engaged in the starting mode;
the starter bracket includes a slideway that is hand-held in contact with the engine platform predeterminedly proximate the flywheel rim for engaging the starter rim with the flywheel rim for the starting mode;
the starter wheel and the starter axle are on a slide that is slidable on the slideway in a direction towards the flywheel to engage the starter rim and the flywheel rim in the starting mode; and
the starter wheel having a power coupling to which a predetermined motorized rotator is coupled predeterminedly.

8. The miniature-engine starter of claim 7 and further comprising:
a push handle on the slide for hand-pushing the slide to the starting mode.

9. The miniature-engine starter of claim 8 and further comprising:
a bracket handle on the starter bracket for hand-holding the starter bracket while hand-pushing the slide to the starting mode with the starter rim and the flywheel rim engaged.

10. The miniature-engine starter of claim 9 wherein:
the starter bracket includes a bracket extension for engaging the engine platform with the slide in the starting mode and for removing the slide from the engine platform rapidly and conveniently after the miniature engine is started.

11. The miniature-engine starter of claim 7 wherein:
the motorized rotator includes a rotator transmission having transmission of an axis of rotation from being collinear with an electrical-rotator axis to being predeterminedly collinear to a starter-wheel axis.

12. The miniature-engine starter of claim 7 wherein:
the starter wheel includes a starter transmission having transmission of an axis of rotation from being collinear with the starter-wheel axis to being predeterminedly collinear to the electrical-rotator axis.

13. The miniature-engine starter of claim 7 wherein:
the flywheel rim includes grip indentations; and
the starter rim includes a rubberlike circumferential outside periphery for resilience gripping of the flywheel rim.

14. The miniature-engine starter of claim 7 wherein:
the flywheel rim includes flywheel gear teeth that are extended radially from the flywheel rim; and
the starter rim includes starter gear teeth that are extended radially from the starter rim to mate with the flywheel gear teeth.

15. A miniature-engine starter for a miniature engine on an engine platform of a model vehicle with a flywheel on the miniature engine having a flywheel rim, said starter comprising:
a starter wheel that is rotatable on a starter axle that is on a starter bracket;
the starter wheel having a starter rim that tangentially engages the flywheel rim in a starting mode;
the starter bracket including a slideway that is attached to the engine platform proximate a side of the flywheel rim;
the starter wheel and the starter axle are on a slide that is slidable on the slideway in a direction towards the flywheel to engage the starter rim and the flywheel rim in the starting mode; and
the starter wheel being coupled to a motorized rotator with a releasable coupling with which the motorized rotator is coupled to the starter wheel removably.

16. The miniature-engine starter of claim 15 and further comprising:
a push handle on the slide for hand-pushing the slide to the starting mode.

17. The miniature-engine starter of claim 15 wherein:
the motorized rotator includes a rotator transmission having transmission of an axis of rotation from being collinear with an electrical-rotator axis to being predeterminedly collinear to a starter-wheel axis.

18. The miniature-engine starter of claim 15 wherein:
the starter wheel includes a starter transmission having transmission of an axis of rotation from being collinear with the starter-wheel axis to being predeterminedly collinear to the electrical-rotator axis.

19. The miniature-engine starter of claim 15 wherein:
the flywheel rim includes grip indentations; and
the starter rim includes a rubberlike circumferential outside periphery for resilience gripping of the flywheel rim.

20. The miniature-engine starter of claim 15 wherein:
the flywheel rim includes flywheel gear teeth that are extended radially from the flywheel rim; and
the starter rim includes starter gear teeth that are extended radially from the starter rim to mate with the flywheel gear teeth.
